(19) United States
(12) Patent Application Publication
(10) Pub. No.: US 2011/0289411 A1
(43) Pub. Date: Nov. 24, 2011

(54) METHOD AND SYSTEM FOR RECORDING USER INTERACTIONS WITH A VIDEO SEQUENCE

(75) Inventors: Girish KULKARNI, Bangalore (IN); Bela Anand, Bangalore (IN); Gunadhar Sareddy, Bangalore (IN); Umamaheswaran Bahusrutham Sridharan, Bangalore (IN); Praveen Saxena, Bangalore (IN); Gaurav Kumar Jain, Bangalore (IN)

(73) Assignee: Samsung Electronics Co., Ltd., Suwon-si (KR)

(21) Appl. No.: 13/114,465

(22) Filed: May 24, 2011

(30) Foreign Application Priority Data
May 24, 2010 (IN) 1427/CHE/2010
Feb. 9, 2011 (KR) 10-2011-0011367

(51) Int. Cl. G06F 3/048

(52) U.S. Cl. 715/719

(57) ABSTRACT

A method and system for recording user interactions with a video sequence is provided. The method includes playing a video sequence receiving a user input in the video sequence, displaying, on the video sequence, a response to the user input, and recording the response into the video sequence.

### PRIORITY

This application claims priority under 35 U.S.C. §119(a) to a patent application filed in the Indian Patent Office on May 24, 2010, which was assigned Serial No. 1427/CHE/2010, and to a Korean Patent Application filed in the Korean Intellectual Property Office on Feb. 9, 2011, which was assigned Serial No. 10-2011-0011367, the content of each of which is hereby incorporated by reference in its entirety.

### BACKGROUND OF THE INVENTION

1. Field of the Invention

The present invention relates generally to modifying multimedia content, and more particularly, to a method and system for recording user interactions with a video sequence.

2. Description of the Related Art

The use of video editing tools in multimedia devices has been increasing over time. In an existing technique, a user of a multimedia device can edit a video sequence to achieve a desired video sequence. For example, the user can choose different editing effects that can be applied to the video sequence, or the user can choose different objects to add to the video sequence. However, the user cannot provide interactions to an object area or a non-object area to generate an interesting video sequence.

Accordingly, a need exists for an efficient technique for recording user interactions, in which user inputs and responses to the user inputs are included.

### SUMMARY OF THE INVENTION

Accordingly, the present invention is designed to address at least the problems and/or disadvantages discussed above and to provide at least the advantages described below. An aspect of the present invention is to provide a method and system for recording user interactions, in which user inputs and responses to the user inputs are included, to get a desired video sequence.

In accordance with an aspect of the present invention, a method is provided for recording user interactions with a video sequence. The method includes playing a predetermined video sequence of a plurality of video sequences; providing and recording at least one user interaction to the video sequence when at least one user input occurs in the video sequence, the at least one user interaction displaying a corresponding object which represents at least one response to the at least one user input.

In accordance with another aspect of the present invention, a system is provided for recording user interactions with a video sequence. The system includes a user interface for receiving at least one user input which occurs in a video sequence; a random generator for generating at least one response to the at least one user input; and a processor operable to play a predetermined video sequence of a plurality of video sequences, and provide and record at least one user interaction through which the corresponding object representing the at least one response to the at least one user input which occurs in the video sequence is displayed in the video sequence.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a block diagram illustrating a system for recording user interactions with a video sequence, in accordance with an embodiment of the invention;

FIG. 2 is a flowchart illustrating a method for recording user interactions with a video sequence, in accordance with an embodiment of the invention;

FIG. 3 is a flowchart illustrating a method for recording user interactions with a video sequence, in accordance with another embodiment of the invention; and

FIGS. 4A to 4L illustrate screen shots of portable terminal during an operation of recording user interactions with a video sequence, in accordance with an embodiment of the present invention.

Throughout the drawings, the same drawing reference numerals will be understood to refer to the same elements, features and structures.

### DETAILED DESCRIPTION OF EMBODIMENTS OF THE INVENTION

Various embodiments of the present invention will now be described in detail with reference to the accompanying drawings. In the following description, specific details, such as detailed configuration and components, are merely provided to assist the overall understanding of certain embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Further, relational terms such as first and second, and the like, may be used to distinguish one entity from another entity, without necessarily implying any actual relationship or order between such entities.

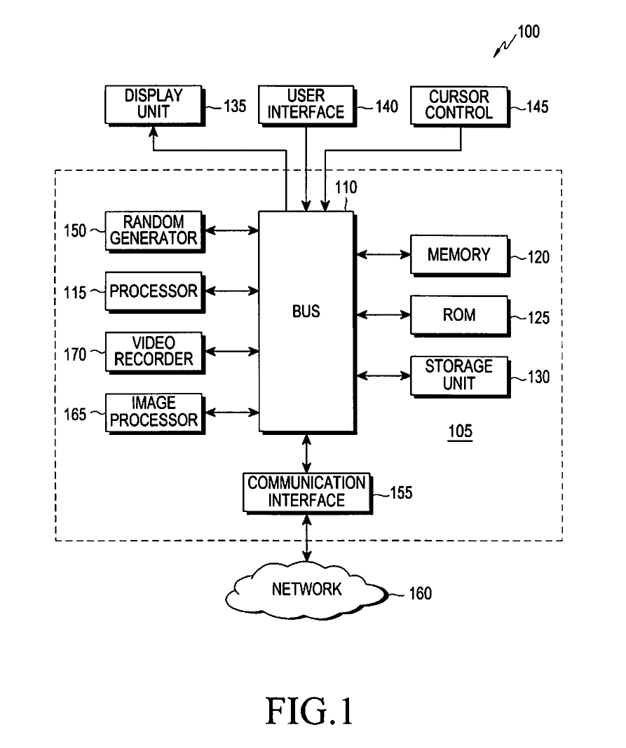

FIG. 1 is a block diagram illustrating a system for recording user interactions with a video sequence, in accordance with an embodiment of the invention.

Referring to FIG. 1, the system 100 includes a multimedia device 105, such as a camcorder, a video player, a digital camera, a computer, a laptop, a mobile device, a digital television, a hand held device, a Personal Digital Assistant (PDA), etc.

The multimedia device 105 includes a bus 110 or other communication mechanism for communicating information, a processor 115 coupled with the bus 110 for processing one or more video sequences, and a memory 120, such as a Random Access Memory (RAM) or other dynamic storage device, connected to the bus 110 for storing information.

The multimedia device 105 further includes a Read Only Memory (ROM) 125 or other static storage device coupled to the bus 110 for storing static information, and a storage unit 130, such as a magnetic disk or optical disk, coupled to the bus 110 for storing information.

The multimedia device 105 can be connected, via the bus 110, to a display unit 135, such as a Cathode Ray Tube (CRT), a Liquid Crystal Display (LCD), or a Light Emitting Diode (LED) display, for displaying information to a user.

Additionally, a user interface 140, e.g., including alphanumeric and other keys, is connected to multimedia device 105 via the bus 110. Another type of user input device is a cursor control 145, for example a mouse, a trackball, or cursor direction keys for communicating input to multimedia device 105 and for controlling cursor movement on the display unit 135. The user interface 140 can be included in the display unit 135, for example, a touch screen. In addition, the user interface 140 can be a microphone for communicating an input based on sound or voice recognition. Basically, the user interface 140 receives user input and communicates the user input to the multimedia device 105.

The multimedia device 105 also includes a random generator 150 for generating one or more responses to a user input. Specifically, the random generator 150 can select random effects to be entered into a video sequence.

The memory 120 stores one or more user interactions for a first video sequence. The user interactions can be the user inputs and the responses to the user inputs.

The processor 115 plays the first video sequence and records the user interactions. The processor 115 also applies the user interactions to the first video sequence to generate a modified first video sequence. Further, the processor 115 applies the user interactions to a second video sequence to obtain a modified second video sequence. In addition, the processor 115 can discard the user interactions. The display unit 135 displays the first video sequence and the second video sequence.

In FIG. 1, the multimedia device 105 includes a video recorder 170 for recording a live video sequence, the modified first video sequence, and the modified second video sequence. However, the recorded video signal may also be provided to the multimedia device 105 from an external video recorder.

The multimedia device 105 also includes an image processor 165, which applies one or more predetermined effects and one or more selected effects to the first video sequence and/or the second video sequence.

Various embodiments are related to the use of the multimedia device 105 for implementing the techniques described herein. In accordance with an embodiment of the present invention, techniques are performed by the processor 115 using information included in the memory 120. The information can be read into the memory 120 from another machine-readable medium, for example, the storage unit 130.

The term “machine-readable medium” as used herein refers to any medium that participates in providing data that causes a machine to operate in a specific fashion. In an embodiment implemented using the device 105, various machine-readable mediums are involved, for example, in providing information to the processor 115. The machine-readable medium can be a storage media. Storage media includes both non-volatile media and volatile media. Non-volatile media includes, for example, optical or magnetic disks, such as the storage unit 130. Volatile media includes dynamic memory, such as the memory 120. All such media is tangible to enable the information carried by the media to be detected by a physical mechanism that reads the information into a machine.

Common forms of machine-readable medium include, for example, a floppy disk, a flexible disk, hard disk, magnetic tape, or any other magnetic medium, a CD-ROM, any other optical medium, punch cards, paper tape, any other physical medium with patterns of holes, a RAM, a Programmable ROM (PROM), an Electronically PROM (EPROM), a FLASH-EPROM, any other memory chip or cartridge, etc.

The multimedia device 105 also includes a communication interface 155 coupled to the bus 110. The communication interface 155 provides a two-way data communication coupling to a network 160. Accordingly, the multimedia device 105 is in electronic communication with other devices through the communication interface 155 and the network 160.

For example, the communication interface 155 can be a Local Area Network (LAN) card for providing a data communication connection to a compatible LAN. Wireless links can also be implemented. In any such implementation, the communication interface 155 sends and receives electrical, electromagnetic or optical signals that carry digital data streams representing various types of information. The communication interface 155 can be a universal serial bus port.

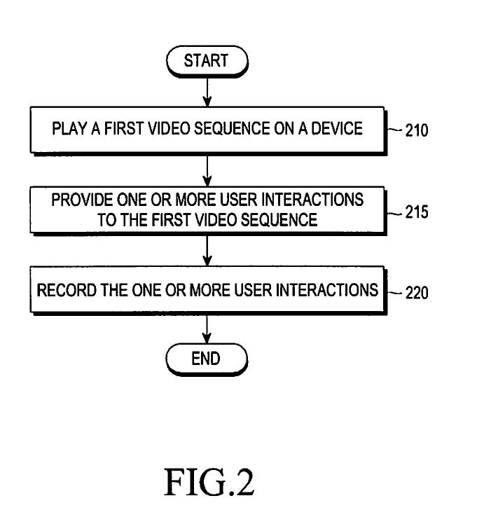

FIG. 2 is a flowchart illustrating a method for recording user interactions with a video sequence, in accordance with an embodiment of the invention.

Referring to FIG. 2, in step 210, a first video sequence is played on a multimedia device. For example, the first video sequence can be a live video sequence or a recorded video sequence. In step 215, a user interaction is provided to the first video sequence, and in step 220, the user interaction is recorded. Additionally, multiple user interactions can be provided to the first video sequence and recorded.

For example, user interactions include selecting an object for display from a menu, a touch screen input, or an audible command.

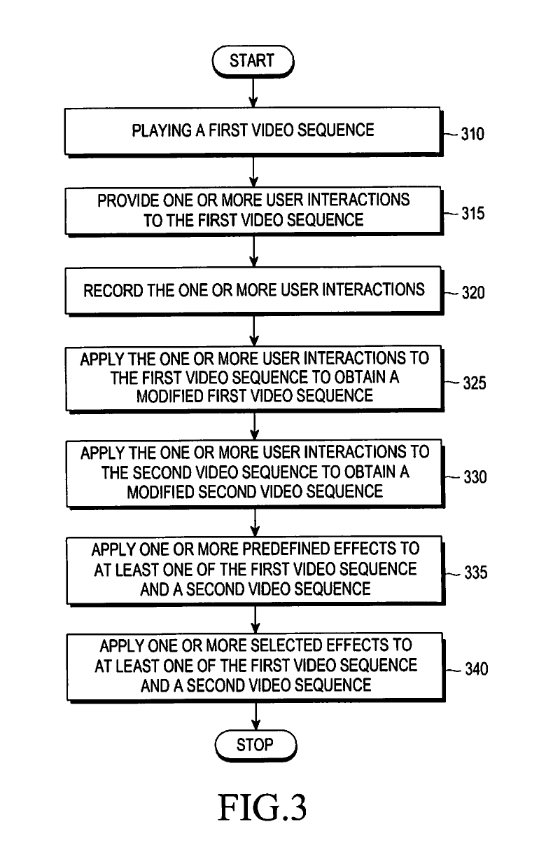

FIG. 3 is a flowchart illustrating a method for recording user interactions with a video sequence, in accordance with an embodiment of the invention.

Referring to FIG. 3, in step 310, a first video sequence is played on a device. For example, the first video sequence can be a live video sequence or a recorded video sequence.

In step 315, a user interaction is provided to the first video sequence. The user interaction is provided by a user providing a user input through a user interface. Examples of the user inputs include, but are not limited to a touch input, a voice command, a key input, a cursor input. The user inputs can be provided through respective user interfaces provided by the device.

In accordance with an embodiment of the present invention, the first video sequence can include a plurality of frames. Each frame can include object areas and non-object areas. The object areas are regions in the frame that include objects that are additionally displayed as a result of a user interaction. For example, a user can add an object, such as a balloon or a bird to a video of the sky.

The objects further provide responses to the user inputs. The responses can be predetermined or can be predefined based on a video sequence or determined by a random generator 150. The responses result in replacement of the objects, which are displayed in the object area. For example, a balloon or bird, as described above, could fly across the screen.

The non-object areas are regions in the frame that do not include objects additionally displayed by the user.

In accordance with an embodiment of the present invention, the user interactions can be discarded, when the user inputs are provided on the non-object areas or to the objects for which there are no associated responses.

In accordance with another embodiment of the present invention, when user interactions are provided to non-object areas or object areas, a predetermined effect can be initiated. The object areas are thus associated with the responses or the predetermined effects. Examples of the predetermined effects include, but are not limited to a rain effect, a lake effect, and a spotlight effect. The predetermined effects can be obtained through the user inputs on the non-objects areas or the object areas, or through a selection of the predetermined effects from a database provided by an image processor 165. As a result, the user interactions modify the frame and subsequent frames of the first video sequence.

For example, when a user plays a first video sequence including an object previously added by the user, e.g., a lit candle, and the user intends to modify the first video sequence, the user can do so by providing a user input on a display unit of a multimedia device displaying the first video sequence. A user input, such as a blow of air can be detected by a touch screen and provided to the object, i.e., the lit candle, in a frame of the first video sequence. In response, the object is modified, i.e., a flame associated with the lit candle is no longer displayed.

In accordance with another embodiment of the present invention, the user input can be provided to the non-object areas in the frame of the first video sequence. As described above, user interactions, i.e., user inputs, provided to the non-object areas, can be discarded for being input into a non-object area or predetermined effects can be initiated, based on device settings. For example, when the first video sequence includes a cake as the object and a user input is provided to an area around the cake, i.e., a non-object area, a response is not provided and the user input can be discarded.

In step 320, the user interactions are recorded. The recording of the user interactions includes recording the user inputs and the responses to the user inputs.

The recording of the user inputs can be performed across the frame of the first video sequence.

Further, the user inputs are recorded by determining a plurality of user input attributes that correspond to each of the user inputs. The user input is recorded in conjunction with a corresponding frame number. Examples of user input attributes include, an input type, input co-ordinates, and an input value to determine the responses. Examples of the input type include, a voice command and a key input. Additionally, a user input can be scalable based on an intensity and duration of intensity of the user input. As a result, different intensities of the user input can provide different responses.

Similarly, the recording of responses to the user inputs is also across the frame of the first video sequence, the subsequent frames of the first video sequence, or both. The responses are recorded by determining the responses to the user inputs. The responses are recorded in conjunction with the corresponding frame number.

In step 325, the user interactions can further be applied to the first video sequence to obtain a modified first video sequence. Likewise, the user interactions can be applied to a second video sequence to obtain a modified second video sequence, in step 330.

The modified first video sequence and the modified second video sequence can be instantly played on the device or can be stored in the device.

In step 335, one or more predefined effects can be applied to at least one of the first video sequence and a second video sequence.

In step 340, one or more selected effects can be applied to at least one of the first video sequence and a second video sequence

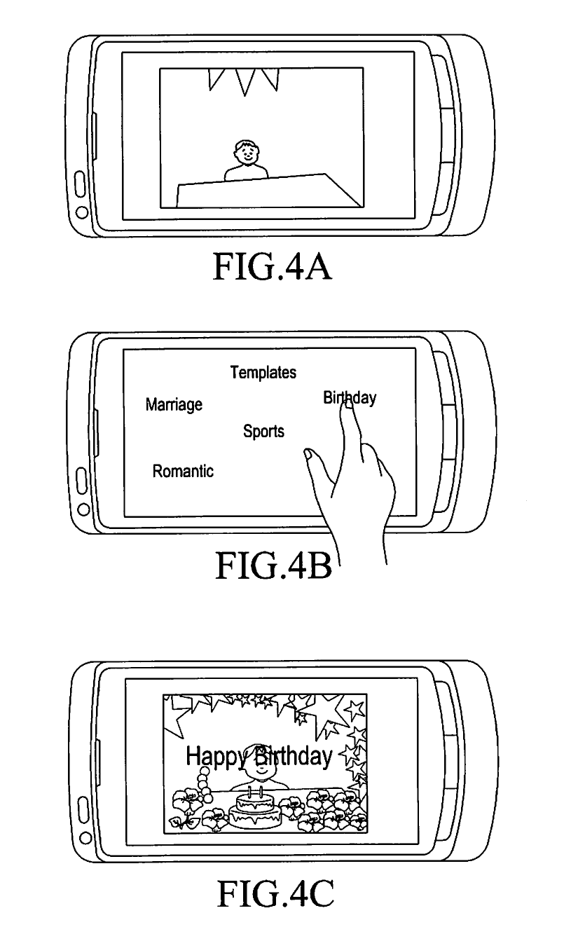

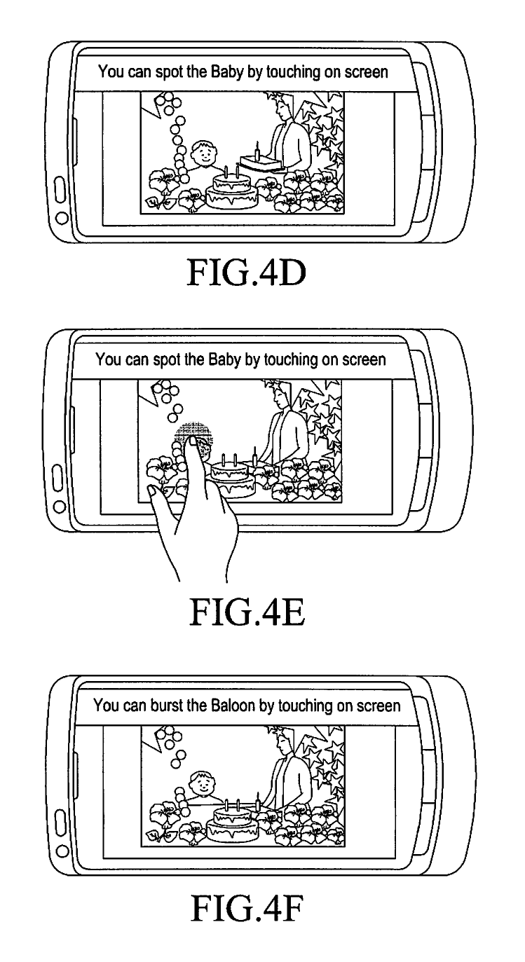

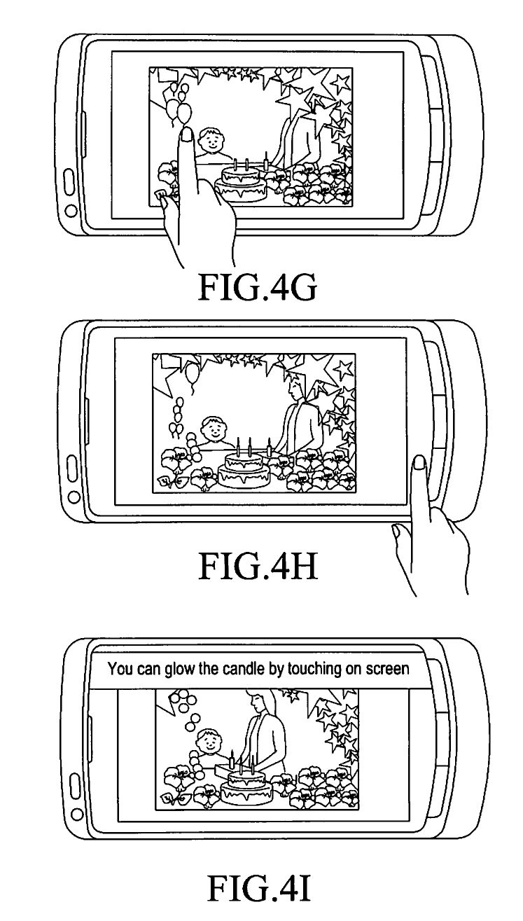

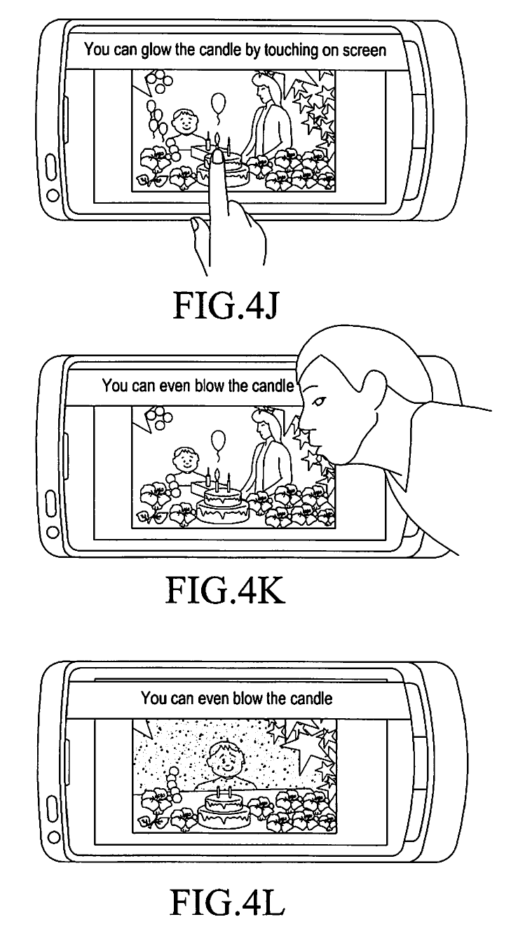

FIGS. 4A to 4L illustrate screen shots of portable terminal during an operation of recording user interactions with a video sequence, in accordance with an embodiment of the present invention. Specifically, FIG. 4A illustrates an example of a birthday video (moving pictures), and when the birthday video (moving pictures) is selected as illustrated in FIG. 4B, the birthday video sequence of FIG. 4A is played while a specific frame is overlaid on the birthday video sequence, as illustrated in FIG. 4C.

While the birthday video sequence of FIG. 4C is played, the caption “You can spot the Baby by touching on screen” is displayed as illustrated in FIG. 4D. In this situation, if a user input is generated by touching the baby on the screen, then the spot light effect is applied to the baby in response to the user input, as illustrated in FIG. 4E.

Further, while the birthday video sequence of FIG. 4C is played, the caption “You can burst the Balloon by touching on screen” is displayed as illustrated in FIG. 4F. In this situation, if a user input is generated by touching the balloon on the screen, as illustrated in FIG. 4G, the effect of bursting the balloon is applied in response to the user input, as illustrated in FIG. 4H.

Further, while the birthday video sequence of FIG. 4C is played, the caption “You can glow the candle by touching on screen” is displayed as illustrated in FIG. 4I. In this situation, if a user input is generated by touching the candle on the screen, the effect of a lit candle is applied in response to the user input, as illustrated in FIG. 4J.

Further, during the video sequence of FIG. 4J, in which the candle is lit, the caption “You can even blow the candle” is displayed as illustrated in FIG. 4K. In this situation, if an audio signal is detected from the user blowing onto the terminal, the effect of blowing out the candle is applied in response to the user input, as illustrated in FIG. 4L. Therefore, the video sequence of FIG. 4A may be changed by recording the operation through FIGS. 4A to 4L.

While the present invention has been shown and described with reference to certain embodiments thereof, it will be understood by those skilled in the art that various changes in form and details may be made therein without departing from the spirit and scope of the present invention as defined by the appended claims and their equivalents.

What claimed is:

1. A method for recording user interactions with a video sequence, the method comprising:
playing a video sequence;
receiving a user input in the video sequence;
displaying, on the video sequence, a response to the user input;
recording the response into the video sequence.

2. The method of claim 1, wherein the video sequence includes a plurality of frames, and
wherein each frame includes an object area in which a corresponding object representing the response to the user input is displayed and a non-object area where no responses are displayed.

3. The method of claim 2, wherein the corresponding object representing the response to the user input is displayed by replacing an object displayed in the object area.

4. The method of claim 1, wherein the user input is recorded along with a frame number corresponding to the video sequence according to an input attribute which corresponds to the user input, and the input attribute includes an input type, input co-ordinates, and an input value.

5. The method of claim 4, wherein the user input is scalable based on an intensity and duration of intensity of the user input.

6. The method of claim 1, wherein the response to the user input is predefined or predetermined according to a video sequence, differs according to the user input, and is recorded along with a frame number corresponding to the video sequence.

7. The method of claim 1, further comprising:
providing and recording a user interaction that applies a predetermined effect or a selected effect to the video sequence when the user input occurs in the video sequence.

8. The method of claim 7, wherein the predetermined effect or the selected effect is applied to an object area and a non-object area that are included in each frame of the video sequence.

9. The method of claim 7, wherein the predetermined effect or the selected effect includes one of a rain effect, a lake effect, and a spotlight effect.

10. The method of claim 1, wherein a user interaction is applied to the video sequence, and the video sequence includes one of a live video sequence and a recorded video sequence.

11. A system for recording user interactions with a video sequence, the system comprising:
a user interface for receiving a user input that occurs in a video sequence;
a random generator for generating a response to the user input; and
a processor that plays a predetermined video sequence of a plurality of video sequences, and provides and records a user interaction through which a corresponding object representing the response to the user input that occurs in the video sequence is displayed in the video sequence.

12. The system of claim 11, wherein the processor changes the video sequence by applying the user interaction.

13. The system of claim 11, wherein the processor replaces an object displayed in an object area that is included in a frame of the video sequence with the corresponding object representing the response to the user input.

14. The system of claim 13, wherein the video sequence includes a plurality of frames, and each frame includes an object area in which the corresponding object representing the response to the user input is displayed and a non-object area in which no responses are displayed.

15. The system of claim 11, wherein the processor records the user input along with a frame number corresponding to the video sequence according to an input attribute of the user input.

16. The system of claim 15, wherein the input attribute includes an input type, input co-ordinates, and an input value, and
wherein the user input is scalable based on an intensity and duration of intensity of the user input.

17. The system of claim 11, wherein the processor records the response to the user input, the response being predefined or predetermined according to the video sequence, differing according to the user input, along with a frame number corresponding to the video sequence.

18. The system of claim 11, further comprising:
an image processor for providing the user interaction that applies a predetermined effect or a selected effect to the video sequence, when the user input occurs in the video sequence.

19. The system of claim 11, wherein the user interaction is applied to the video sequence, and
wherein the video sequence includes one of a live video sequence and a recorded video sequence.
